(19) United States
(12) Patent Application Publication
(10) Pub. No.: US 2017/0082796 A1
(43) Pub. Date: Mar. 23, 2017

(54) MODE FILTERING OPTICAL FIBRE

(71) Applicant: JIANGSU UNIVERSITY, Jiangsu (CN)

(72) Inventor: Mingyang CHEN, Jiangsu (CN)

(21) Appl. No.: 15/126,247

(22) PCT Filed: Apr. 28, 2015
(86) PCT No.: PCT/CN2015/077615

§ 371 Date: Sep. 14, 2016

(30) Foreign Application Priority Data
Dec. 24, 2014 (CN) 201410816602.4

(51) Int. Cl. G02B 6/02

(52) U.S. Cl. CPC G02B 6/0238; G02B 6/02385; G02B 6/02333; G02B 6/02352; G02B 6/02361

(57) ABSTRACT

A microstructured optical fiber has periodically arranged high-index rods embedded in a low-index background, a high-index ring surrounding the high-index rods, and a high-index core located at the center. The high-index rods and the low-index background forms a microstructured cladding region which supports the guidance of supermodes. The fundamental and the highest supermodes form a cladding-mode band, wherein at least the effective index of a core mode lies in the cladding-mode band. Also provided is

a technique for selectively filtering the fiber modes, to selectively filter out one or some of the high-order modes with the other modes still guided in the core with low loss. The cascade of optical fibers can filter out a group of fiber modes, marking guidance of a single high-order mode in a few-mode optical fiber possible.

### TECHNICAL FIELD

This invention relates to optical communications based on few-mode optical fibers, in particular a microstructured optical fiber that is able to selectively filter the guided modes.

### BACKGROUND OF THE PRESENT INVENTION

The data capacity carried by a single-mode fiber has been increased rapidly by the wavelength division multiplexing (WDM) and polarization technology. In order to further increase transmission capacity in optical fibers, mode-division multiplexing (MDM) has been proposed. MDM is based on a few-mode fiber, and using its spatial modes as an additional degree of freedom to increase the number of data channels. Few mode optical fibers operating at higher-order modes have also found applications for large-mode area operation, dispersion compensation, femtosecond pulse delivery for Ti:Sapphire femtosecond lasers, and nonlinear application, etc.

For such system applications, mode multiplexing/demultiplexing device works as a key component to effectively convert the fundamental mode into a high-order mode. One of the most effective method is using long-period-grating, which has shown the ability of mode conversion with low cross-talk. Another commonly used configuration is using the binary-phase spatial light filters. Alternative methods based on photonic lanterns, volume holograms, MMI configuration, multi-core optical fiber, and waveguide configurations, have also been proposed.

The mode multiplexing/demultiplexing devices for MDM application should have low cross-talk. That is, the power ratio between the amount of unwanted mode and the selective excited mode at the output port should be low. To this aim, we can apply a mode filter at the end of the multiplexing/demultiplexing devices. Just like an optical filter used in single-mode fibers, mode filters that are able to selectively eliminate specified modes while keep the other modes at low loss levels, would be important for the tailoring of modes in few-mode optical fibers. Mode filter could be an efficient component to suppress the cross-talks of mode operating devices. It can also be used as an efficient tool to eliminating the modes in few-mode fibers, which should be beneficial for high-order mode based applications.

By simply bending few-mode optical fibers at a specified bending radius range, the suppression of high-order modes is possible, which is based on the fact that high-order modes generally have higher bending losses than low-order modes. The suppressing of fundamental mode in few-mode step-index or graded-index optical fibers is generally difficult, because low order modes are confined more tightly in the core. So far, the technique of suppressing a mode that lies between the fundamental mode and the highest order mode in photonic bandgap fibers has not been reported.

### SUMMARY OF THE PRESENT INVENTION

This invention provides a microstructured optical fiber that is able to selectively filter the guided modes.

A microstructured optical fiber consists of periodically arranged high-index rods 1 embedded in a low-index background 2, a high-index ring 3 surrounding the high-index rods, and a high-index core 4 located at the center, wherein the high-index rods and the low-index background forms a microstructured cladding region which supports the guidance of supermodes, wherein the fundamental and the highest supermodes form a cladding-mode band, wherein at least the effective index of a core mode lies in the cladding-mode band, wherein the relationship between the refractive indexes of the core n_{core}, the background n_{clad}, the high-index rods n_{rod}, and the high-index ring nₒᵤₜ, should meet the condition of nₒᵤₜ>n_{clad}, n_{core}>n_{clad}, and n_{rod}>n_{clad}, wherein the core parameters should meet the condition of >2.405, where

$$V = \frac{2 π {r}_{core}}{{λ}_{0}} {( {n}_{core}^{2} - {n}_{clad}^{2} )}^{1 / 2} ,$$

r_{core} is the core radius, and λ₀ is the operating wavelength.

According to the invention, the refractive index of the high-index ring is higher than the effective indexes of all the supermodes.

Preferably the relationship between the inner diameter of the high-index ring dᵢₙ, the radius of the high-index rods r_{rod}, and the maximum center-to-center distance between the high-index rods and the core Lₘₐₓ should meet the condition of dᵢₙ−Lₘₐₓ−r_{rod}<4 μm.

Preferably the ring number of high-index rods N should meet the condition of N≧3 .

Preferably the minimum center-to-center distance between the high-index rods and the core Sₘᵢₙ should meet the condition of Sₘᵢₙ−(r_{core}+r_{rod})≧3 μm and Sₘᵢₙ−(r_{core}+r_{rod})≧8 μm

Preferably the relationship between the refractive index of the high-index ring nₒᵤₜ and the effective index of the fundamental supermode n_{ceff} should meet the condition of nₒᵤₜ−n_{ceff}>0.0005.

To filter out two or more modes, more than one type of high-index rods may be applied. The microstructured cladding can be composed of 2 or 3 types of high-index rods, each type of high-index rods have the same radius, refractive index, and period, wherein the high-index rods of a type forms 1 to 3 regions, and the centers of the high-index rods in a region are fallen in a sector area.

Preferably the cross-section of the optical fiber is of axial symmetry.

By filling the core and/or the rod areas with high-index liquid, the refractive indexes of the core and/or the rods can be tuned by controlling the temperature, which offers the possibility of achieving tunable mode-selective filtering with the fiber.

The invention provides a technique that can selectively filtering the fiber modes, the high-index ring introduces large confinement losses for the cladding modes, whereas the coupling of the core mode with the leaky cladding modes introduces high confinement loss for the core mode. The fundamental mode in a few-mode optical fiber can be filtered out and therefore only the higher-order mode is guided. It can also be applied to selectively filter out one or some of the high-order modes with the other modes still guided in the core with low loss. The cascade of different invention optical fibers can filter out a group of fiber modes, as a result, the guidance of a single high-order mode in a few-mode optical fiber is possible.

### BRIEF DESCRIPTION OF THE DRAWINGS

FIG. 1 is a cross-sectional diagram of an optical fiber according to an embodiment of the present invention;

FIG. 2 is a cross-sectional diagram of an optical fiber with high-index rods of two different sizes according to an embodiment of the present invention;

FIG. 3 is a cross-sectional diagram of another optical fiber with high-index rods of two different sizes according to an embodiment of the present invention;

FIG. 4 is the field distributions of the LP₀₁ mode (a) and LP₁₁ mode (b) for an optical fiber according to an embodiment of the present invention as shown in FIG. 1;

FIG. 5 is the effective indexes (a) and confinement losses (b) of the core modes for an optical fiber according to an embodiment of the present invention as shown in FIG. 1.

FIG. 6 is the transmission loss of the fundamental core mode as a function of transmission distance for an optical fiber according to an embodiment of the present invention as shown in FIG. 1.

FIG. 7 is the confinement losses of the core modes as functions of inner diameter of the high-index ring for an optical fiber according to an embodiment of the present invention as shown in FIG. 1;

FIG. 8 is the confinement losses of the core modes as functions of the refractive index of the high-index ring for an optical fiber according to an embodiment of the present invention as shown in FIG. 1;

FIG. 9 is the effective indexes (a) and confinement losses (b) of the core modes for an optical fiber according to an embodiment of the present invention as shown in FIG. 1.

FIG. 10 is a cross-sectional diagram of another optical fiber according to an embodiment of the present invention;

FIG. 11 is the confinement losses of the core modes for an optical fiber according to an embodiment of the present invention as shown in FIG. 10;

### DETAILED DESCRIPTION OF THE PRESENT INVENTION

FIG. 1 shows the cross-sectional diagram of an optical fiber according to an embodiment of the present invention. According to the invention there is provided a photonic bandgap cladding optical fiber comprising periodically arranged high-index rods embedded in a low-index background and a high-index core located at the center the core. The step-index core supports the guidance of higher-order modes. In addition, the high-index rods and the low-index background forms a microstructured cladding region which supports the guidance of supermodes.

According to the theory of photonic bandgap fiber, the guidance of lights in the microstructured cladding would be forbidden in the specified wavelength and mode index regions. Therefore, those core modes with effective indexes located in the bandgap region will be guided by the bandgap effect. Since the microstructured cladding is composed of high-index rods in the background of low index material, the microstructured cladding would be able to form cladding modes whose effective indexes are higher than that of the background index, which can be understood as the result of splitting the fundamental mode of a single rod into a large number of supermodes by bringing a large number of identical rods together. Therefore, if a core mode has low index difference with a supermode, then the core mode would couple with the supermode. Low-index difference between the two modes is a premier requirement for strong mode coupling. Therefore, as long as the number of high-index rods is large enough, there would be sufficient large number of cladding modes in the cladding mode band, if the effective index of a core mode lies in the cladding mode band, strong mode coupling would happen.

The high-index ring plays an important role on the elimination of core mode. In order to introduce leakage mechanism, the refractive index of the high-index ring should be higher than that of the background. Preferably the refractive index of the high-index ring should be higher than the effective indexes of all the supermodes. The index-guiding mechanism is therefore broken, and high leakage losses are introduce to the supermodes.

It is important to apply a high-index ring. In fact, if high-index ring is not introduced, then both the core modes and the cladding modes would have higher indexes than the background index, which means the core modes and cladding modes are guided based on index-guiding effect without confinement losses. To induce high leakage losses for the supermodes, the refractive index of the high-index ring should be higher than those of the supermodes, that is, the refractive index of the high-index ring nₒᵤₜ should be higher than the effective index of the fundamental supermode n _{ceff}. Preferably the relationship between the refractive index of the high-index ring nₒᵤₜ and the effective index of the fundamental supermode n_{ceff} may meet the condition of nₒᵤₜ−n_{ceff}>0.0005.

The high-index ring should be closer to the high-index rods, in this way, the guidance of the supermodes by index guiding will be difficult, as a result, the supermodes will experience high leakage losses. Preferably the relationship between the inner diameter of the high-index ring dᵢₙ, the maximum center-to-center distance between the high-index rods and the core Lₘₐₓ should meet the condition of dᵢₙ−Lₘₐₓ−r_{rod}<4 μm.

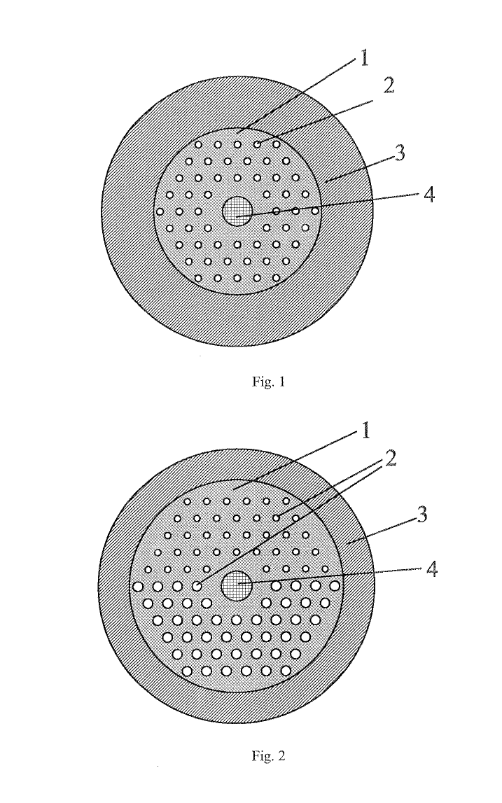

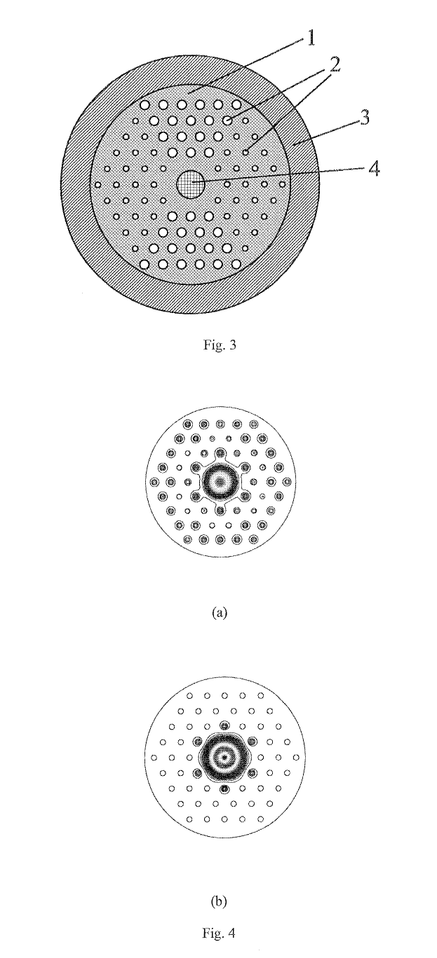

By applying two or more types of high-index rods, it is possible to filter out a few core modes. The high-index rods of a type forms 1 to 3 regions, and the high-index rods in a region are fallen in a sector area. A core mode, of which the effective index of a core mode lies in the cladding-mode band will couple with the supernodes in the region, and filtered out. Therefore, high-index rods of different types can filter out different core modes. FIGS. 2 and 3 show examples of the present invention with two types of high-index rods.

The core should be closer enough with the high-index rods, so that the coupling between the core mode and the supermodes are strong enough. It is also important that the distance should not be to closer so that the guided core mode would still keep a regular mode field. The center-to-center distance between the core and the high-index rods adjacent the core Sₘᵢₙ should meet the condition of Sₘᵢₙ−(r_{core}+r_{rod})≧3 μm and Sₘᵢₙ−(r_{core}+r_{rod})≦8 μm.

### Embodiment 1

FIG. 1 is a cross-sectional diagram of an optical fiber according to an embodiment of the present invention. FIG. 4 show the field profiles of the LP₀₁ and LP₁₁ modes of this embodiment. The LP₀₁ mode shows a strong coupling with the cladding mode. As a contrast, the LP₁₁ mode is confined in the core, although it also has some energy located in the first ring of the high-index rods.

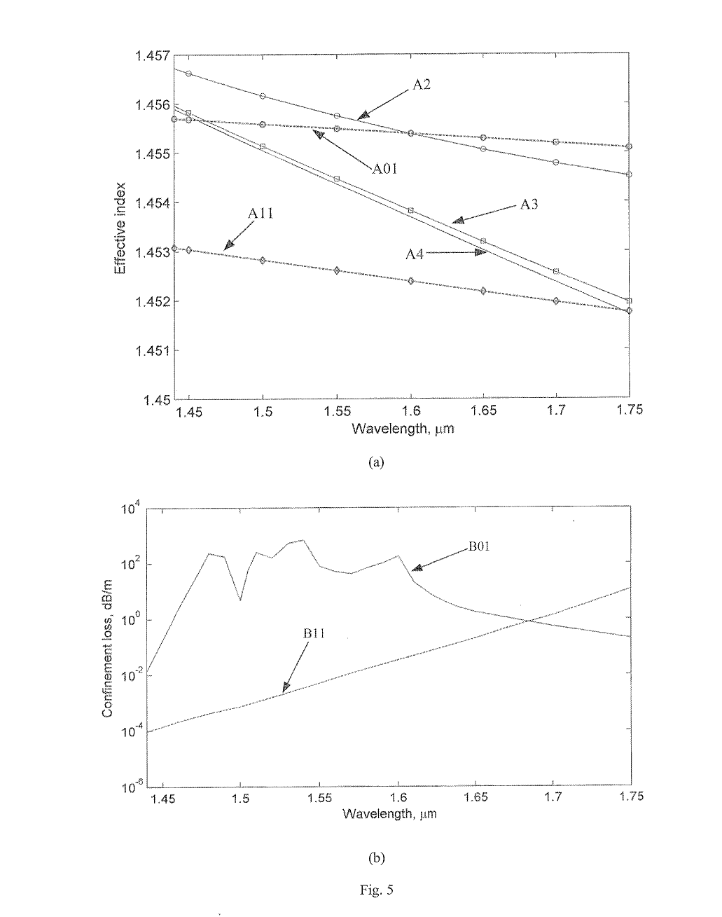

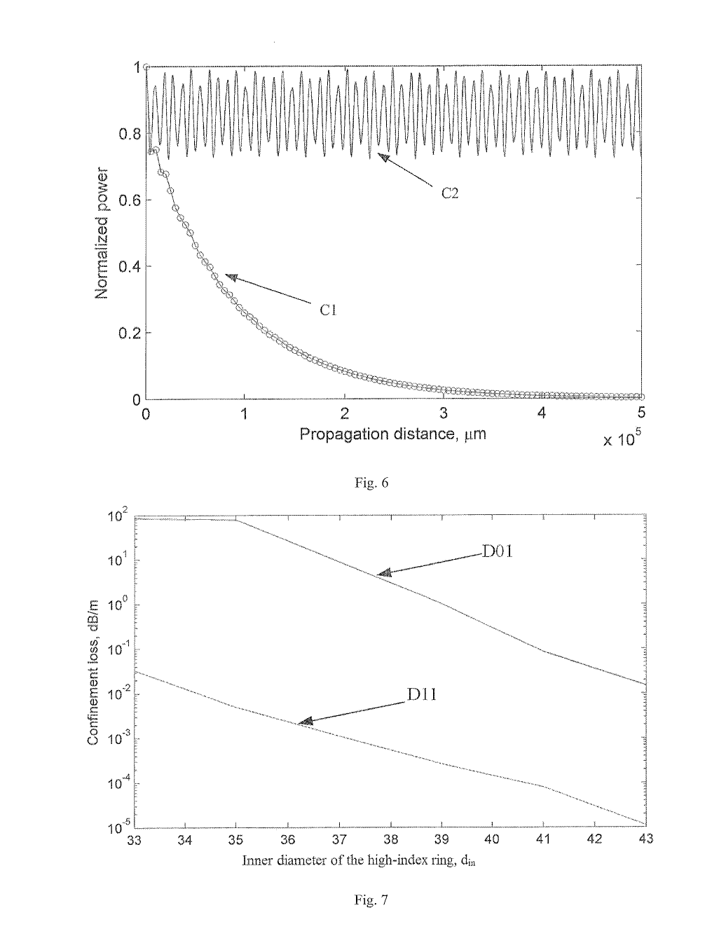

FIG. 5(a) show the effective indexes of the core modes for an optical fiber according to an embodiment of the present invention as shown in FIG. 1. In particular, curves A01 and A11 show the effective indexes of the LP₀₁ and LP₁₁ modes. Curves A2 and A3 are the upper and lower limits of the cladding mode band. Curve A4 is the upper edge of the bandgap. The lower limit of the cladding-mode band approaches the upper edge of the bandgap. The mode indexes of the cladding modes are following in a narrow index range for a fixed wavelength as the figure shows. Introducing more high-index rods will reduce the gap between the cladding mode index and the top boundary of the bandgap. Low-index difference between the two modes is a premier requirement for strong mode coupling. Since so many cladding modes exist in the narrow index range, if the effective index of the fundamental core mode lies in the cladding mode region, strong mode coupling would happen. As shown in FIG. 5(a), the LP₁₁ mode index lies in the bandgap region, whereas the LP₀₁ mode index lies in the cladding mode region for a wide wavelength range.

The confinement losses of the core modes as functions of wavelength are shown in FIG. 5(b). The LP₁₁ mode shows increased confinement loss as wavelength increases. The LP₀₁ mode with effective index located at the cladding mode region shows a quite complex variation of confinement loss as the wavelength varies, which is owing to the fact that the LP₀₁ mode will couple with different cladding modes at different situation. Therefore, the coupling efficiency would be different. The confinement loss of the LP₀₁ mode reduces with the increase of index difference between the LP₀₁ mode and the cladding modes. The wide operating bandwidth is owing to the existence of a large number of cladding modes in a narrow region, which ensures strong coupling as the core mode lies in the region.

The guiding mechanics of the LP₁₁ mode in the fiber is different with that of a conventional bandgap fiber because the introduction of the high-index rods will actually increase the confinement loss of the LP₁₁ mode in the proposed fiber. In another words, the high-index rods in the cladding do not contribute to the guiding of the LP₁₁ mode at this situation. The main function of the periodic high-index rods would be forming the cladding modes in a specified region, so that the cladding modes will couple with the core modes whose effective indexes lie in the bandgap region and simultaneously avoid the coupling with the other core modes.

Curve C1 in FIG. 6 shows the transmission loss of the LP₁₁ mode of an example without high-index ring. It shows the LP₀₁ mode couples with the cladding supermodes periodically. Curve C2 in FIG. 6 shows the transmission loss of the LP₀₁ mode of an example with high-index ring. The introduction of high-index ring can effective increase the confinement loss of the LP₀₁ mode. Therefore, the high-index ring plays an important role on the elimination of the LP₀₁ mode.

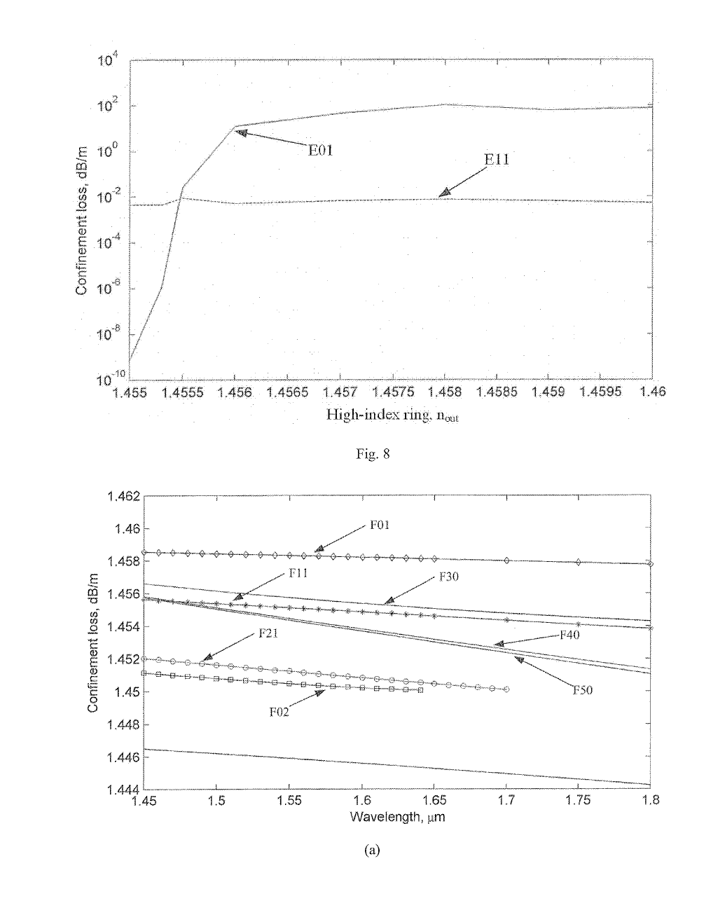

FIG. 7 shows the confinement losses of the core modes as functions of inner diameter of the high-index ring dᵢₙ. We can see the microstructured cladding diameter dᵢₙ should be small enough to break the index guiding mechanism of the cladding modes, so that the confinement loss of the LP₀₁ mode could be high enough. FIG. 8 is the confinement losses of the core modes as functions of the refractive index of the high-index ring nₒᵤₜ for an optical fiber according to an embodiment of the present invention. It shows the refractive index of the high-index ring has little influence on the confinement loss of the LP₁₁ mode, whereas the LP₀₁ mode would experience high loss as the refractive index of the high-index ring is higher enough. A basic criterion is the refractive index of the high-index ring should be higher than the effective indexes of the cladding modes. The fact that the LP₁₁ mode has little interaction with the microstructured cladding leads to the weak influence by the variation of outer cladding index.

### Embodiment 2

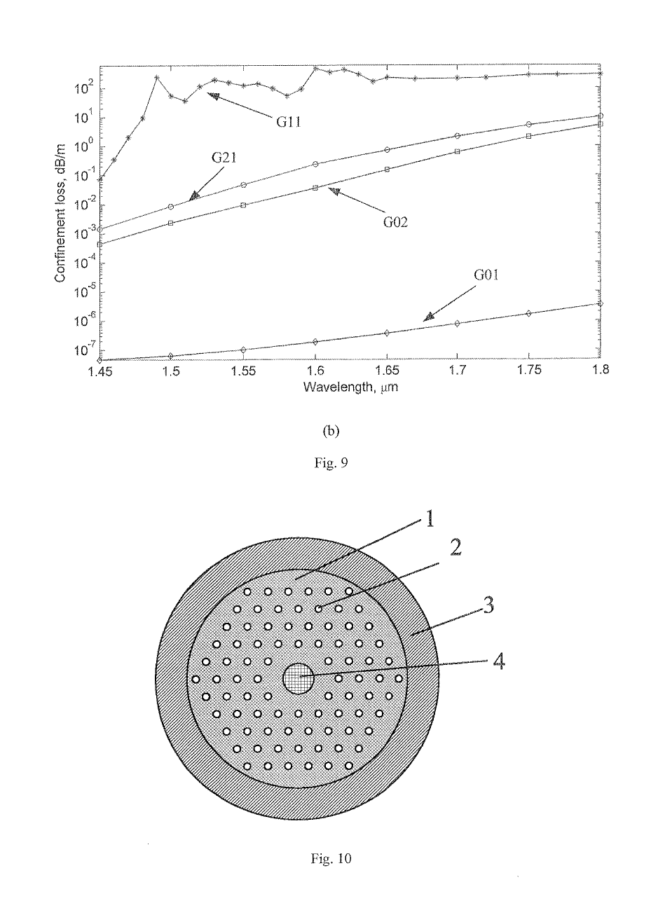

The configuration is shown in FIG. 1. The effective indexes and confinement losses of the core modes in the fiber as functions of wavelength are shown in FIG. 9. The core is able to support the guidance of the LP₀₁, LP₁₁, LP₂₁, and LP₀₂ modes. FIG. 9(a) shows the effective indexes of the core modes and the supermode hand. Curves F01, F11, F21, and F02 show the effective indexes of the LP₀₁, LP₁₁, LP₂₁, and LP₀₂ modes, respectively. Curves F30 and F40 are the upper and lower boundary of the supermode band. Curve F50 is the bandgap edge of the high-index rods. The effective index of the LP₁₁ mode lies in the supermode band at wide bandwidth, whereas the index curves of the LP₀₁, LP₂₁, and LP₀₂ modes lie out of the bandgap region.

Curves G01, G11, G21, and G02 show the confinement losses of the LP₀₁, LP₁₁, LP₂₁, and LP₀₂ modes. As shown in FIG. 9(a), the LP₁₁ mode lies in the cladding mode band at wide wavelength range, which is why the high loss region of the LP_{H} mode is so wide. The losses of the LP₀₁ mode is always low, which is contributed to its high index contrast with the cladding modes. As for the LP₂₁ and LP₀₂ modes, the losses increase with the increase of wavelength.

### Embodiment 3

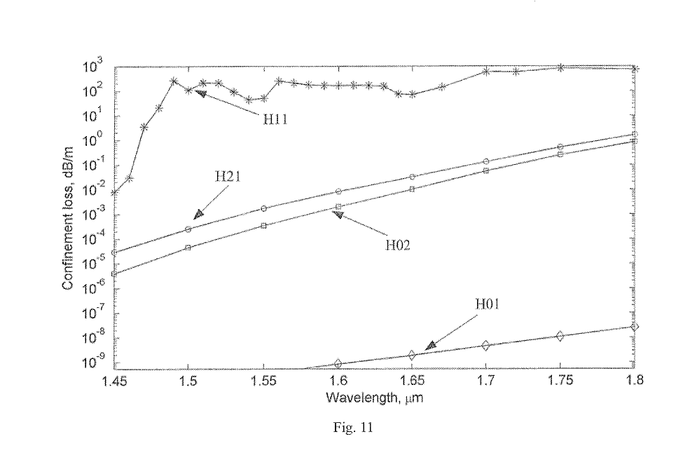

The configuration is shown in FIG. 10. The ring number of high-index rods is N=4. The effective indexes and confinement losses of the core modes in the fiber as functions of wavelength are shown in FIG. 11. Curves H01, H 11, H 21, and H 02 show the confinement losses of the LP₀₁, LP₁₁, LP₂₁, and LP₀₂ modes.

Compared with the results of embodiment 2, the confinement losses of the LP₂₁ and LP₀₂ modes in the present embodiment are reduced effectively, while the LP₁₁ mode still maintains a high loss.

1. A microstructured optical fiber comprising periodically arranged high-index rods embedded in a low-index background, a high-index ring surrounding the high-index rods, and a high-index core located at the center, wherein the high-index rods and the low-index background forms a microstructured cladding region which supports the guidance of supermodes, wherein the fundamental and the highest supermodes form a cladding-mode band, wherein at least the effective index of a core mode lies in the cladding-mode band, wherein the relationship between the refractive indexes of the core n_{core}, the background n_{clad}, the high-index rods n_{rod}, and the high-index ring ₒᵤₜ meet the condition of nₒᵤₜ>n_{clad}, n_{core}>n_{clad}, and n_{rod}>n_{clad}, and wherein the core parameters should meet the condition of V>2.405 , where
$$V = \frac{2 π {r}_{core}}{{λ}_{0}} {( {n}_{core}^{2} - {n}_{clad}^{2} )}^{1 / 2} ,$$
r_{core} is the core radius, and λ₀ is the operating wavelength.

2. The microstructured optical fiber as claimed in claim 1, wherein the refractive index of the high-index ring is higher than the effective indexes of all the supermodes.

3. The microstructured optical fiber as claimed in claim 1, wherein the relationship between the inner diameter of the high-index ring dᵢₙ, the radius of the high-index rods r_{rod}, and the maximum center-to-center distance between the high-index rods and the core Lₘₐₓ meets the condition of dᵢₙ−Lₘₐₓ−r_{rod}<4 μm.

4. The microstructured optical fiber as claimed in claim 1, wherein the ring number of high-index rods N meets the condition of N≦3.

5. The microstructured optical fiber as claimed in claim 1, wherein the minimum center-to-center distance between the high-index rods and the core Sₘᵢₙ meets the condition of Sₘᵢₙ−(r_{core}+r_{rod})≧3 μm and Sₘᵢₙ−(R_{core}+r_{rod})≦8 μm.

6. The microstructured optical fiber as claimed in claim 3, wherein the relationship between the refractive index of the high-index ring nₒᵤₜ and the effective index of the fundamental supermode n_{ceff} meets the condition of nₒᵤₜ−n_{ceff}>0.0005.

7. The microstructured optical fiber as claimed in claim 3, wherein the microstructured cladding is composed of 2 or 3 types of high-index rods, each type of high-index rods have the same radius, refractive index, and period, wherein the high-index rods of a type forms 1 to 3 regions, and the centers of the high-index rods in a region are fallen in a sector area.

8. The microstructured optical fiber as claimed in claim 7, wherein the cross-section of the optical fiber is of axial symmetry.

9. The microstructured optical fiber as claimed in claim 1, wherein the core is filled with high-index liquid.

10. The microstructured optical fiber as claimed in claim 1, wherein the high-index rods is replaced by high-index liquid.
